(19) United States
(12) Patent Application Publication
(10) Pub. No.: US 2012/0039402 A1
(43) Pub. Date: Feb. 16, 2012

(54) MULTIPLE INPUT MULTIPLE OUTPUT COMMUNICATION SYSTEM USING AT LEAST TWO CODEBOOKS

(75) Inventors: Bruno CLERCKX, Seoul (KR); Jun Il CHOI, Seoul (KR); Ki Il KIM, Yongin-si (KR)

(73) Assignee: SAMSUNG ELECTRONICS CO. LTD., Suwon-si (KR)

(21) Appl. No.: 13/205,881

(22) Filed: Aug. 9, 2011

Related U.S. Application Data
(60) Provisional application No. 61/372,170, filed on Aug. 10, 2010.

(30) Foreign Application Priority Data
Feb. 10, 2011 (KR) 10-2011-0011945

(51) Int. Cl. H04L 27/00

(52) U.S. Cl. 375/259

(57) ABSTRACT

An apparatus and method for a communication system including a transmitter and a receiver are provided. The method may include using a first codebook including first codewords and a second codebook including second codewords. The receiver may generate a first precoding matrix indicator corresponding to one of the first codewords and a second precoding matrix indicator corresponding to one of the second codewords. The transmitter may generate a precoding matrix based on the first precoding matrix indicator and the second precoding matrix indicator.

### PRIORITY

This application claims the benefit under 35 U.S.C. §119(e) of U.S. provisional application No. 61/372,170, filed on Aug. 10, 2010 in the U.S. Patent and Trademark Office, and the benefit under 35 U.S.C. §119(a) of Korean patent application No. 10-2011-0011945, filed on Feb. 10, 2011, in the Korean Intellectual Property Office, the entire disclosure of each of which is hereby incorporated by reference.

### BACKGROUND OF THE INVENTION

1. Field of the Invention

The present invention relates to an apparatus and method for controlling a communication system. More particularly, the present invention relates to a Multiple Input Multiple Output (MIMO) communication system to share channel information using a codebook.

2. Description of Related Art

In a Multiple Input Multiple Output (MIMO) communication system, a transmitter and a receiver may use a codebook to share channel information. The channel information may include channel direction information and channel quality information.

The codebook may include a plurality of codewords. The receiver may select a single codeword from the plurality of codewords, and may feed back, to the transmitter, a precoding matrix indicator indicating an index of the selected codeword. The precoding matrix indicator may be one example of the channel direction information.

The transmitter may verify a codeword selected by the receiver, based on the precoding matrix indicator, and may generate a precoding matrix based on the codeword selected by the receiver. The transmitter may precode data based on the precoding matrix and transmit the precoded data via a plurality of transmit antennas. A number of transmit antennas may be variously determined, for example, 2, 4, 8, and the like.

### SUMMARY OF THE INVENTION

Aspects of the present invention are to address at least the above-mentioned problems and/or disadvantages and to provide at least the advantages described below.

In accordance with an aspect of the present invention, a communication method of a receiver in a communication system including a transmitter and the receiver is provided. The method includes accessing a memory storing a first codebook including first codewords and a second codebook including second codewords, generating a first precoding matrix indicator corresponding to one of the first codewords and a second precoding matrix indicator corresponding to one of the second codewords, and transmitting, to the transmitter, the first precoding matrix indicator and the second precoding matrix indicator.

When the transmitter includes four transmit antennas, the second codewords may include one of

$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$

and θ may correspond to a real number.

In accordance with another aspect of the present invention, a communication method of a receiver in a communication system including a transmitter and the receiver is provided. The method includes accessing a memory storing a first codebook including first codewords and a second codebook including second codewords, generating a first precoding matrix indicator corresponding to one of the first codewords and a second precoding matrix indicator corresponding to one of the second codewords, and transmitting, to the transmitter, the first precoding matrix indicator and the second precoding matrix indicator. The first precoding matrix indicator may indicate a preferred T matrix that is defined by applying a diagonal operation to at least one column vector included in one of the first codewords. At least one column vector included in each of the second codewords may include diagonal elements present in at least one matrix of

$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$

and θ may correspond to a real number.

In accordance with still another aspect of the present invention, a communication method of a transmitter in a communication system including the transmitter and a receiver is provided. The method includes receiving a first precoding matrix indicator and a second precoding matrix indicator, accessing a memory storing a first codebook including first codewords and a second codebook including second codewords, and generating a precoding matrix based on a first codeword indicated by the first precoding matrix indicator and a second codeword indicated by the second precoding matrix indicator. Each of the second codewords may correspond to a diagonal matrix.

In accordance with yet another aspect of the present invention, a communication method of a transmitter in a communication system including the transmitter and a receiver is provided. The method includes receiving a first precoding matrix indicator and a second precoding matrix indicator, accessing a memory storing a first codebook including first codewords and a second codebook including second codewords, and generating a precoding matrix based on a first codeword indicated by the first precoding matrix indicator and a second codeword indicated by the second precoding matrix indicator. The precoding matrix indicator may indicate a preferred T matrix that is defined by applying a diagonal operation to at least one column vector included in one of the first codewords. At least one column vector included in each of the second codewords may include diagonal elements present in at least one matrix of

$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$

and θ may correspond to a real number.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a Multiple Input Multiple Output (MIMO) communication system according to an exemplary embodiment of the present invention.

FIG. 2 is a diagram illustrating a communication method of a receiver and a transmitter to share channel information using a single codebook according to an exemplary embodiment of the present invention.

FIG. 3 is a diagram illustrating a conceptual relationship between two codebooks and a precoding matrix according to an exemplary embodiment of the present invention.

FIG. 4 is a diagram illustrating a communication method of a receiver and a transmitter to share channel information using two codebooks according to an exemplary embodiment of the present invention.

FIG. 5 is a diagram illustrating a communication apparatus according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, description of well-known functions and constructions may be omitted for i clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

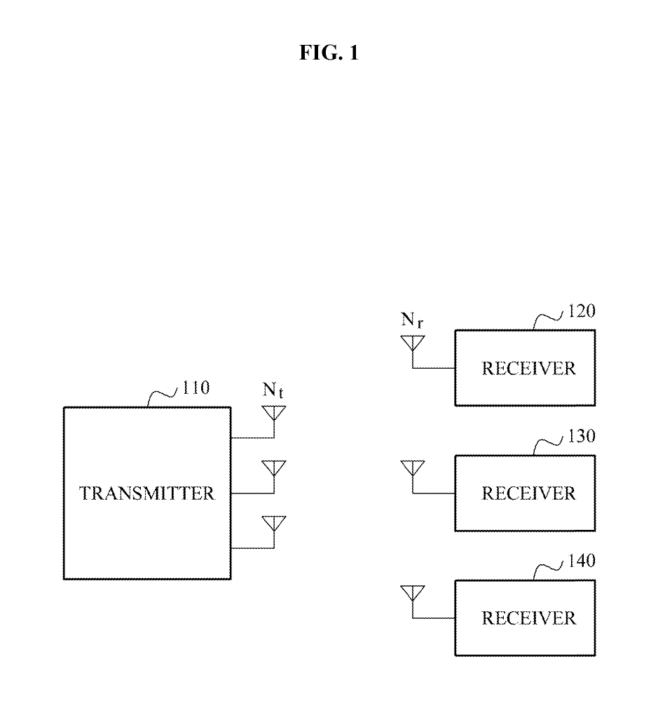

FIG. 1 illustrates a Multiple Input Multiple Output (MIMO) communication system according to an exemplary embodiment of the present invention.

Referring to FIG. 1, the MIMO communication system may include a transmitter 110 and a plurality of receivers 120, 130, and 140.

Nₜ transmit antennas may be installed in the transmitter 110. The transmitter 110 may function as a base station in a downlink, and may function as a terminal in an uplink. Nᵣ receive antennas may be installed in the receivers 120, 130, and 140. Each of the receivers 120, 130, and 140 may function as a terminal in the downlink, and may function as a base station in the uplink. Hereinafter, exemplary embodiments will be described based on an operation of the transmitter 110 and the receivers 120, 130, and 140 in the downlink. The exemplary embodiments may be applicable to the uplink.

Channels may be formed between the transmitter 110 and the receivers 120, 130, and 140. Data may be transmitted from the transmitter 110 to the receivers 120, 130, and 140 via the channels. The transmitter 110 may precode at least one data stream using a precoding matrix, enhancing a performance of the MIMO communication system. A data stream may also be referred to as data.

The transmitter 110 may generate a more accurate precoding matrix by verifying information associated with channel direction and information associated with channel quality. Information associated with the channel direction and information associated with the channel quality may be one example of channel information. Information associated with the channel direction may include a precoding matrix indicator.

For example, the transmitter 110 and the receivers 120, 130, and 140 may share the precoding matrix indicator using a codebook. The codebook may include a plurality of codewords. Each of the plurality of codewords may correspond to a vector or a matrix. A size of the codebook may correspond to a number of codewords. For example, a 3-bit codebook may include eight codewords, and a 4-bit codebook may include 16 codewords.

Each of the receivers 120, 130, and 140 may select a single codeword from the plurality of codewords, and may generate an indicator of the selected codeword as a precoding matrix indicator. The precoding matrix indicator may be fed back to the transmitter 110. The transmitter 110 may verify a codeword indicated by the precoding matrix indicator, using the codebook. The transmitter 110 may generate an optimal precoding matrix based on the codeword corresponding to the precoding matrix indicator.

A dimension of a precoding matrix may be dependent on a rank of the transmitter 110. The rank of the transmitter 110 may correspond to a number of data streams desired to be transmitted or a number of layers of the transmitter 110.

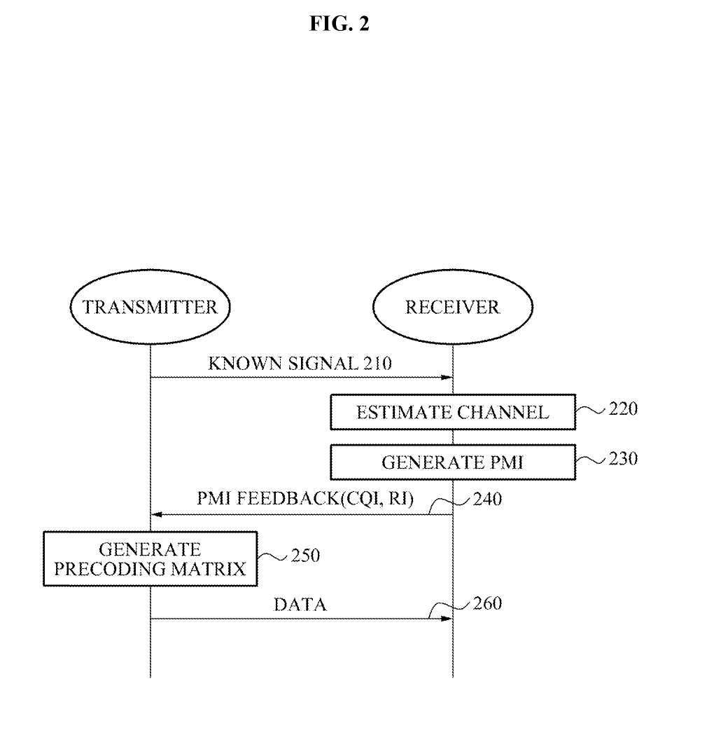

FIG. 2 illustrates a communication method of a receiver and a transmitter to share channel information using a single codebook according to an exemplary embodiment of the present invention.

Referring to FIG. 2, at step 210, the transmitter may transmit a well-known signal to the receiver. The well-known signal may be a pilot signal.

At step 220, the receiver may estimate a channel formed from the transmitter to the receiver based on the well-known signal.

At step 230, the receiver may select, from a codebook, a codeword suitable for the estimated channel and generate a precoding matrix indicator including an index of the selected codeword. In this example, the same codebook may be stored in both the transmitter and the receiver.

At step 240, the receiver may feed back a precoding matrix indicator to the transmitter. The receiver may also feed back channel quality information and a rank indicator.

At step 250, the transmitter may generate an optimal precoding matrix based on the fed back precoding matrix indicator. At step 260, the transmitter may transmit data using the precoding matrix.

The communication method of the transmitter and the receiver when the transmitter and the receiver use the same single codebook is described above with reference to FIG. 2. According to exemplary embodiments, two codebooks may be used for the receiver and the transmitter to share two precoding matrix indicators.

Hereinafter, it is assumed that a first codebook C₁ and a second codebook C₂ are present, and two codebooks are stored in the receiver and the transmitter, respectively. It is also assumed that a precoding matrix W is finally recommended by the receiver and is used by the transmitter.

### Rotation-Based Differential Codebook W₂W₁

Exemplary embodiments may define a precoding matrix W according to Equation 1.

W=W₂W₁ Equation 1

In Equation 1, W₁ corresponds to a preferred first precoding matrix of a receiver corresponding to a first precoding matrix indicator selected by the receiver from the first codebook C₁, and W₂ corresponds to a preferred second precoding matrix of a receiver corresponding to a second precoding matrix indicator selected by the receiver from the second codebook C₂. The first codebook C₁ or the first precoding matrix indicator may be used to indicate a property of a channel in a wideband including a plurality of subbands or to indicate a long-term property of the channel. The second codebook C₂ or the second precoding matrix indicator may be used to indicate a property of a channel in a subband or to indicate a short-term property of the channel. The first codebook C₁ may be well defined in various standards, for example, a 3^{rd} Generation Partnership Project (3GPP) Long Term Evolution (LTE) Release 8 standard, and the like. For example, the first codebook C₁ may correspond to a codebook defined with respect to four transmit antennas in the 3GPP LTE Release 8 standard.

Regardless of the definition of first codewords included in the first codebook C₁, exemplary embodiments may provide various candidates of the second codebook C₂. Each of second codewords included in the second codebook C₂ may be a diagonal matrix. When the transmitter has four transmit antennas, each of the second codewords may be defined through the following functions. Since one of the second codewords is selected as W₂, a structure of the second codewords may be defined by defining a probable structure of W₂ according to Equation 2.

$$Function S \text{:} {W}_{2} = [ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] \\ Function D 1 \text{:} {W}_{2} = [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] \\ Function D 2 \text{:} {W}_{2} = [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] \qquad Equation 2$$

In Equation 2, θ corresponds to a real number and may have a variety of values. For example, θ may correspond to one of 0, π, π/2, −π/2, −π/8, π/8, −π/16, π/16, −3π/16, 3π/16, −π/32, π/32, −3π/32, and 3π/32.

Referring to Table 1, second codewords of the second codebook C₂ may be defined by applying a corresponding function to entry θ within the table. For example, the following Table 1 may be assumed.

TABLE 1

| θ | 0 | π | π/2 | −π/2 | −π/8 | π/8 | −π/16 | π/16 | −3π/16 | 3π/16 | −π/32 | π/32 | −3π/32 | 3π/32 |
|---|---|---|---|---|---|---|---|---|---|---|---|---|---|---|
| C2 | D1 | D1 | D1 | D1 | | | | | | | S | S | S | S |

In this example, the second codebook C₂ may include eight second codewords. For example, D1 may be applied to θ=0, π, π/2, and −π/2, and S may be applied to −π/32, π/32, −3π/32, and 3π/32. When k denotes an index of each of the eight second codewords (k=1, 2, . . . , 8), first through fourth second codewords in the second codebook C₂ may be defined as follows:

$${C}_{2 , 1 … 4} = \{ [ \begin{matrix}1 & & & \\ & 1 & & \\ & & 1 & \\ & & & 1\end{matrix} ] , [ \begin{matrix}1 & & & \\ & 1 & & \\ & & - 1 & \\ & & & - 1\end{matrix} ] , [ \begin{matrix}1 & & & \\ & 1 & & \\ & & j & \\ & & & 1\end{matrix} ] , [ \begin{matrix}1 & & & \\ & 1 & & \\ & & - j & \\ & & & - j\end{matrix} ] \}$$

Similarly, fifth through eighth second codewords in the second codebook C₂ may be defined as follows:

$${C}_{2 , 5 … 8} = \{ \begin{matrix}[ \begin{matrix}1 & & & \\ & {e}^{- jπ / 32} & & \\ & & {e}^{- j2π / 32} & \\ & & & {e}^{- j3π / 32}\end{matrix} ] , & [ \begin{matrix}1 & & & \\ & {e}^{jπ / 32} & & \\ & & {e}^{j2π / 32} & \\ & & & {e}^{j3π / 32}\end{matrix} ] , \\ [ \begin{matrix}1 & & & \\ & {e}^{- j3π / 32} & & \\ & & {e}^{- j6π / 32} & \\ & & & {e}^{- j9π / 32}\end{matrix} ] , & [ \begin{matrix}1 & & & \\ & {e}^{j3π / 32} & & \\ & & {e}^{j6π / 32} & \\ & & & {e}^{j9π / 32}\end{matrix} ]\end{matrix} \}$$

In this example, a final precoding matrix W may be defined based on the first precoding matrix indicator and the second precoding matrix indicator. More specifically, the final precoding matrix W may be expressed as a multiplication between one of C_{2,k} and one of the first codewords included in the first codebook C₁.

Probable candidates of the second codebook C₂ may be various. For example, the probable candidates of the second codebook C₂ may be defined according to Table 2.

TABLE 2

| θ | 1 | −1 | j | −j | −π/4 | π/4 | −π/8 | π/8 | −π/16 | π/16 | −3π/16 | 3π/16 | −π/32 | π/32 | −3π/32 | 3π/32 | −π/20 | π/20 | −π/10 | π/10 |
|---|---|---|---|---|---|---|---|---|---|---|---|---|---|---|---|---|---|---|---|---|
| C₂ | D1 | D1 | D1 | D1 | | | | | | | | | S | S | S | S | | | | |
| C₂ | | | | | | | | | | | | | S, | S, | S, | S, | | | | |
| | | | | | | | | | | | | | D2 | D2 | D2 | D2 | | | | |
| C₂ | | | | | | | | | D2 | D2 | D2 | D2 | S | S | S | S | | | | |
| C₂ | S | | | | | | | S | S | S | | | | | | | | | | |
| C₂ | D1 | D1 | | | D2 | D2 | | | | | | | S | S | S | S | | | | |
| C₂ | D1 | D1 | | | | | D2 | D2 | | | | | S | S | S | S | | | | |
| C₂ | D1 | D1 | | | | | | | D2 | D2 | | | S | S | S | S | | | | |
| C₂ | D1 | D1 | | | | | | | | | D2 | D2 | S | S | S | S | | | | |
| C₂ | D1 | D1 | | | | | | | | | | | S, | S, | S | S | | | | |
| | | | | | | | | | | | | | D2 | D2 | | | | | | |
| C₂ | D1 | D1 | | | | | | | | | | | S | S | S, D2 | S, D2 | | | | |
| C₂ | D1 | | D1 | | D2 | D2 | | | | | | | S | S | S | S | | | | |
| C₂ | D1 | | D1 | | | | D2 | D2 | | | | | S | S | S | S | | | | |
| C₂ | D1 | | D1 | | | | | | D2 | D2 | | | S | S | S | S | | | | |
| C₂ | D1 | | D1 | | | | | | | | D2 | D2 | S | S | S | S | | | | |
| C₂ | D1 | | D1 | | | | | | | | | | S, | S, | S | S | | | | |
| | | | | | | | | | | | | | D2 | D2 | | | | | | |
| C₂ | D1 | | D1 | | | | | | | | | | S | S | S, | S, | | | | |
| | | | | | | | | | | | | | | | D2 | D2 | | | | |
| C₂ | | | D1 | D1 | | | D2 | D2 | | | | | S | S | S | S | | | | |
| C₂ | | | D1 | D1 | | | | | D2 | D2 | | | S | S | S | S | | | | |
| C₂ | | | D1 | D1 | | | | | | | D2 | D2 | S | S | S | S | | | | |
| C₂ | | | D1 | D1 | | | | | | | | | S, | S, | S | S | | | | |
| | | | | | | | | | | | | | D2 | D2 | | | | | | |
| C₂ | | | D1 | D1 | | | | | | | | | S | S | S, | S, | | | | |
| | | | | | | | | | | | | | | | D2 | D2 | | | | |
| C₂ | D1 | | | | | D1 | D2 | D2 | | | | | S | S | S | S | | | | |
| C₂ | D1 | | | | | D1 | | | D2 | D2 | | | S | S | S | S | | | | |
| C₂ | D1 | | | | | D1 | | | | | D2 | D2 | S | S | S | S | | | | |
| C₂ | D1 | | | | | D1 | | | | | | | S, | S, | S | S | | | | |
| | | | | | | | | | | | | | D2 | D2 | | | | | | |
| C₂ | D1 | | | | | D1 | | | | | | | S | S | S, | S, | | | | |
| | | | | | | | | | | | | | | | D2 | D2 | | | | |
| C₂ | D1 | | | | D1 | | D2 | D2 | | | | | S | S | S | S | | | | |
| C₂ | D1 | | | | D1 | | | | D2 | D2 | | | S | S | S | S | | | | |
| C₂ | D1 | | | | D1 | | | | | | D2 | D2 | S | S | S | S | | | | |
| C₂ | D1 | | | | D1 | | | | | | | | S, | S, | S | S | | | | |
| | | | | | | | | | | | | | D2 | D2 | | | | | | |
| C₂ | D1 | | | | D1 | | | | | | | | S | S | S, | S, | | | | |
| | | | | | | | | | | | | | | | D2 | D2 | | | | |
| C₂ | D1 | | | | | | D2 | D1D2 | | | | | S | S | S | S | | | | |
| C₂ | D1 | | | | | | | D1 | D2 | D2 | | | S | S | S | S | | | | |
| C₂ | D1 | | | | | | | D1 | | | D2 | D2 | S | S | S | S | | | | |
| C₂ | D1 | | | | | | | D1 | | | | | S, | S, | S | S | | | | |
| | | | | | | | | | | | | | D2 | D2 | | | | | | |
| C₂ | D1 | | | | | | | D1 | | | | | S | S | S, | S, | | | | |
| | | | | | | | | | | | | | | | D2 | D2 | | | | |
| C₂ | D1 | | | | | | D1, D2 | D2 | | | | | S | S | S | S | | | | |
| C₂ | D1 | | | | | | D1 | | D2 | D2 | | | S | S | S | S | | | | |
| C₂ | D1 | | | | | | D1 | | | | D2 | D2 | S | S | S | S | | | | |
| C₂ | D1 | | | | | | D1 | | | | | | S, | S, | S | S | | | | |
| | | | | | | | | | | | | | D2 | D2 | | | | | | |
| C₂ | D1 | | | | | | D1 | | | | | | S | S | S, | S, | | | | |
| | | | | | | | | | | | | | | | D2 | D2 | | | | |
| C₂ | | | | | | | | | | | | | S, | S, | S, | S, | | | | |
| | | | | | | | | | | | | | D1 | D1 | D1 | D1 | | | | |
| C₂ | D1 | D1 | | | D2 | D2 | | | | | | | | | | | S | S | S | S |
| C₂ | D1 | D1 | | | | | D2 | D2 | | | | | | | | | S | S | S | S |
| C₂ | D1 | D1 | | | | | | | D2 | D2 | | | | | | | S | S | S | S |
| C₂ | D1 | D1 | | | | | | | | | D2 | D2 | | | | | S | S | S | S |
| C₂ | D1 | D1 | | | | | | | | | | | D2 | D2 | | | S | S | S | S |
| C₂ | D1 | D1 | | | | | | | | | | | | | D2 | D2 | S | S | S | S |
| C₂ | D1 | | D1 | | D2 | D2 | | | | | | | | | | | S | S | S | S |
| C₂ | D1 | | D1 | | | | D2 | D2 | | | | | | | | | S | S | S | S |
| C₂ | D1 | | D1 | | | | | | D2 | D2 | | | | | | | S | S | S | S |
| C₂ | D1 | | D1 | | | | | | | | D2 | D2 | | | | | S | S | S | S |
| C₂ | D1 | | D1 | | | | | | | | | | D2 | D2 | | | S | S | S | S |
| C₂ | D1 | | D1 | | | | | | | | | | | | D2 | D2 | S | S | S | S |
| C₂ | | | D1 | D1 | D2 | D2 | | | | | | | | | | | S | S | S | S |
| C₂ | | | D1 | D1 | | | D2 | D2 | | | | | | | | | S | S | S | S |
| C₂ | | | D1 | D1 | | | | | D2 | D2 | | | | | | | S | S | S | S |
| C₂ | | | D1 | D1 | | | | | | | D2 | D2 | | | | | S | S | S | S |
| C₂ | | | D1 | D1 | | | | | | | | | D2 | D2 | | | S | S | S | S |
| C₂ | | | D1 | D1 | | | | | | | | | | | D2 | D2 | S | S | S | S |
| C₂ | D1 | | | | D2 | D1, | | | | | | | | | | | S | S | S | S |
| | | | | | | D2 | | | | | | | | | | | | | | |
| C₂ | D1 | | | | | D1 | D2 | D2 | | | | | | | | | S | S | S | S |
| C₂ | D1 | | | | | D1 | | | D2 | D2 | | | | | | | S | S | S | S |
| C₂ | D1 | | | | | D1 | | | | | D2 | D2 | | | | | S | S | S | S |
| C₂ | D1 | | | | | D1 | | | | | | | D2 | D2 | | | S | S | S | S |
| C₂ | D1 | | | | | D1 | | | | | | | | | D2 | D2 | S | S | S | S |
| C₂ | D1 | | | | D1, | D2 | | | | | | | | | | | S | S | S | S |
| | | | | | D2 | | | | | | | | | | | | | | | |
| C₂ | D1 | | | | D1 | | D2 | D2 | | | | | | | | | S | S | S | S |
| C₂ | D1 | | | | D1 | | | | D2 | D2 | | | | | | | S | S | S | S |
| C₂ | D1 | | | | D1 | | | | | | D2 | D2 | | | | | S | S | S | S |
| C₂ | D1 | | | | D1 | | | | | | | | D2 | D2 | | | S | S | S | S |
| C₂ | D1 | | | | D1 | | | | | | | | | | D2 | D2 | S | S | S | S |
| C₂ | D1 | | | | D2 | D2 | | D1 | | | | | | | | | S | S | S | S |
| C₂ | D1 | | | | | | D2 | D1, | | | | | | | | | S | S | S | S |
| | | | | | | | | D2 | | | | | | | | | | | | |
| C₂ | D1 | | | | | | | D1 | D2 | D2 | | | | | | | S | S | S | S |
| C₂ | D1 | | | | | | | D1 | | | D2 | D2 | | | | | S | S | S | S |
| C₂ | D1 | | | | | | | D1 | | | | | D2 | D2 | | | S | S | S | S |
| C₂ | D1 | | | | | | | D1 | | | | | | | D2 | D2 | S | S | S | S |
| C₂ | D1 | | | | D2 | D2 | D1 | | | | | | | | | | S | S | S | S |
| C₂ | D1 | | | | | | D1, | D2 | | | | | | | | | S | S | S | S |
| | | | | | | | D2 | | | | | | | | | | | | | |
| C₂ | D1 | | | | | | D1 | | D2 | D2 | | | | | | | S | S | S | S |
| C₂ | D1 | | | | | | D1 | | | | D2 | D2 | | | | | S | S | S | S |
| C₂ | D1 | | | | | | D1 | | | | | | D2 | D2 | | | S | S | S | S |
| C₂ | D1 | | | | | | D1 | | | | | | | | D2 | D2 | S | S | S | S |
| C₂ | | | | | | | | | | | | | D1 | D1 | D1 | D1 | S | S | S | S |
| C₂ | D1 | D1 | D1 | D1 | | | S | S | S | S | | | | | | | | | | |
| C₂ | D2 | D2 | D2 | D2 | | | S | S | S | S | | | | | | | | | | |
| C₂ | | | | | | | S | S | S | S | | | D2 | D2 | D2 | D2 | | | | |
| C₂ | | | | | | | S | S | S, | S, | D2 | D2 | | | | | | | | |
| | | | | | | | | | D2 | D2 | | | | | | | | | | |
| C₂ | | | | | | | S, | S, | S, | S, | | | | | | | | | | |
| | | | | | | | D2 | D2 | D2 | D2 | | | | | | | | | | |
| C₂ | | | | | D2 | D2 | S, | S, | S | S | | | | | | | | | | |
| | | | | | | | D2 | D2 | | | | | | | | | | | | |
| C₂ | D2 | D2 | | | D2 | D2 | S | S | S | S | | | | | | | | | | |
| C₂ | D2 | | D2 | | D2 | D2 | S | S | S | S | | | | | | | | | | |
| C₂ | | | | | | | S | S | S | S | | | D1 | D1 | D1 | D1 | | | | |
| C₂ | D1 | D1 | | | | | S | S | S | S | | | D2 | D2 | | | | | | |
| C₂ | D1 | D1 | | | | | S | S | S | S | | | | | D2 | D2 | | | | |
| C₂ | D1 | D1 | | | | | S | S | S | S | D2 | D2 | | | | | | | | |
| C₂ | D1 | D1 | | | | | S | S | S, | S, | | | | | | | | | | |
| | | | | | | | | | D2 | D2 | | | | | | | | | | |
| C₂ | D1 | D1 | | | | | S, | S, | S | S | | | | | | | | | | |
| | | | | | | | D2 | D2 | | | | | | | | | | | | |
| C₂ | D1 | D1 | | | D2 | D2 | S | S | S | S | | | | | | | | | | |
| C₂ | D1 | D1 | D2 | D2 | | | S | S | S | S | | | | | | | | | | |
| C₂ | D1 | | | | | D1 | S | S | S | S | | | D2 | D2 | | | | | | |
| C₂ | D1 | | | | | D1 | S | S | S | S | | | | | D2 | D2 | | | | |
| C₂ | D1 | | | | | D1 | S | S | S | S | D2 | D2 | | | | | | | | |
| C₂ | D1 | | | | | D1 | S | S | S, | S, | | | | | | | | | | |
| | | | | | | | | | D2 | D2 | | | | | | | | | | |
| C₂ | D1 | | | | | D1 | S, | S, | S | S | | | | | | | | | | |
| | | | | | | | D2 | D2 | | | | | | | | | | | | |
| C₂ | D1 | | | | D2 | D1, | S | S, | S | S | | | | | | | | | | |
| | | | | | | D2 | | | | | | | | | | | | | | |
| C₂ | D1 | | D2 | D2 | | D1 | S | S | S | S | | | | | | | | | | |
| C₂ | D1 | | | | D1 | | S | S | S | S | | | D2 | D2 | | | | | | |
| C₂ | D1 | | | | D1 | | S | S | S | S | | | | | D2 | D2 | | | | |
| C₂ | D1 | | | | D1 | | S | S | S | S | D2 | D2 | | | | | | | | |
| C₂ | D1 | | | | D1 | | S | S | S, | S, | | | | | | | | | | |
| | | | | | | | | | D2 | D2 | | | | | | | | | | |
| C₂ | D1 | | | | D1 | | S, | S, | S | S | | | | | | | | | | |
| | | | | | | | D2 | D2 | | | | | | | | | | | | |
| C₂ | D1 | | | | D1, | D2 | S | S | S | S | | | | | | | | | | |
| | | | | | D2 | | | | | | | | | | | | | | | |
| C₂ | D1 | | D2 | D2 | D1 | | S | S | S | S | | | | | | | | | | |
| C₂ | D1 | | D1 | | | | S | S | S | S | | | D2 | D2 | | | | | | |
| C₂ | D1 | | D1 | | | | S | S | S | S | | | | | D2 | D2 | | | | |
| C₂ | D1 | | D1 | | | | S | S | S | S | D2 | D2 | | | | | | | | |
| C₂ | D1 | | D1 | | | | S | S | S, | S, | | | | | | | | | | |
| | | | | | | | | | D2 | D2 | | | | | | | | | | |
| C₂ | D1 | | D1 | | | | S, | S, | S | S | | | | | | | | | | |
| | | | | | | | D2 | D2 | | | | | | | | | | | | |
| C₂ | D1 | | D1 | | D2 | D2 | S | S | S | S | | | | | | | | | | |
| C₂ | D1 | | D1, | D2 | | | S | S | S | S | | | | | | | | | | |
| | | | D2 | | | | | | | | | | | | | | | | | |
| C₂ | D1 | D1 | D2 | D2 | | | | | S | S | S | S | | | | | | | | |
| C₂ | D1 | D1 | | | | | D2 | D2 | S | S | S | S | | | | | | | | |

Another probable candidate of the second codebook C₂ may be defined based on Table 3 as well as Table 2.

TABLE 3

| θ | 1 | −1 | j | −j | −π/4 | π/4 | −π/8 | π/8 | −π/16 | π/16 | −3π/16 | 3π/16 | −π/32 | π/32 | −3π/32 | 3π/32 | −π/20 | π/20 | −π/10 | π/10 |
|---|---|---|---|---|---|---|---|---|---|---|---|---|---|---|---|---|---|---|---|---|
| C₂ | D1 | | D1 | | | | D2 | D2 | | | | | S | S | S | S | | | | |

First through eighth second codewords of the second codebook C₂ defined based on Table 3 may be expressed as follows:

$${C}_{2 , 1 … 4} = \{ [ \begin{matrix}1 & & & \\ & 1 & & \\ & & 1 & \\ & & & 1\end{matrix} ] , [ \begin{matrix}1 & & & \\ & 1 & & \\ & & j & \\ & & & j\end{matrix} ] , [ \begin{matrix}1 & & & \\ & {e}^{- jπ / 8} & & \\ & & 1 & \\ & & & {e}^{- jπ / 8}\end{matrix} ] , [ \begin{matrix}1 & & & \\ & {e}^{jπ / 8} & & \\ & & 1 & \\ & & & {e}^{jπ / 8}\end{matrix} ] \}$$

$${C}_{2 , 5 … 8} = \{ \begin{matrix}[ \begin{matrix}1 & & & \\ & {e}^{- jπ / 32} & & \\ & & {e}^{- j2π / 32} & \\ & & & {e}^{- j3π / 32}\end{matrix} ] , & [ \begin{matrix}1 & & & \\ & {e}^{jπ / 32} & & \\ & & {e}^{j2π / 32} & \\ & & & {e}^{j3π / 32}\end{matrix} ] , \\ [ \begin{matrix}1 & & & \\ & {e}^{- j3π / 32} & & \\ & & {e}^{- j6π / 32} & \\ & & & {e}^{- j9π / 32}\end{matrix} ] , & [ \begin{matrix}1 & & & \\ & {e}^{j3π / 32} & & \\ & & {e}^{j6π / 32} & \\ & & & {e}^{j9π / 32}\end{matrix} ]\end{matrix} \}$$

The aforementioned candidates of the second codebook C₂ may provide a 3-bit codebook. More particularly, predetermined subsets of the second codebook C₂ may be used for rank 2 or more.

### Transformation-Based Differential Codebook

A precoding matrix W finally used by the transmitter may be defined by an inner product between matrices T₁ and W₂.

W=T₁W₂

The T matrix may be generated based on W₁ corresponding to the first precoding matrix indicator among codewords included in the first codebook C₁.

(1) Rank 1 Case:

T₁=diag(W₁)

The T matrix T₁ may be defined by applying a diagonal operation to W₁. When X is a matrix, the diagonal operation diag(X) may transform the matrix X to a column vector including diagonal elements of X. When X is a vector, that is, a matrix including a single column, the diagonal operation diag(X) may transform the vector X to a diagonal matrix including, as diagonal elements, elements included in the vector X.

Since W₁ corresponds to a column vector in rank 1 case, T₁ may correspond to the diagonal matrix including, as diagonal elements, elements included in W₁.

(2) Rank 2 Case:

In rank 2 case, each of first codewords included in the first codebook may include two column vectors. Each of the first codewords may be divided into two parts. For example, W₁ may be divided into two column vectors w₁ and w₂.

$${W}_{1} = [ \begin{matrix}\vert & \vert \\ {w}_{1} & {w}_{2} \\ \vert & \vert\end{matrix} ]$$

When the receiver selects a first codeword W₁ from the first codebook, the T matrix may be defined by applying the diagonal operation to each of the column vectors included in W₁ as follows:

T₁=[diag(w₁)diag(w₂)]

where the T matrix corresponds to an Nₜ×(2Nₜ) matrix.

As described above, W₁ may be selected from the first codebook C₁ based on a wideband channel property or a long-term channel property, and W₂ may be selected from the second codebook C₂ based on a subband channel property or a short-term channel property. More particularly, the first codebook C₁ may be well defined in various standards, for example, a 3GPP LTE Release 8 standard. The second codebook C₂ may be described as follows.

C_{2,r,k} may be assumed as a k^{th} codeword of the second codebook C₂ for rank r.

For rank 1, C_{2,1,k} may be defined to establish C_{2,1,k}=diag(C_{2,k}). In this example, C_{2,k} may be assumed to be defined based on Table 1 through Table 3.

For rank 2, C_{2,2,k} may be defined to establish

$${C}_{2 , 2 , k} = [ \begin{matrix}{C}_{2 , 1 , k} & {0}_{4 \times 1} \\ {0}_{4 \times 1} & {C}_{2 , 1 , k}\end{matrix} ] .$$

For example, C_{2,k} may be assumed as follows:

| θ | 0 | π | π/2 | −π/2 | −π/8 | π/8 | −π/16 | π/16 | −3π/16 | 3π/16 | −π/32 | π/32 | −3π/32 | 3π/32 |
|---|---|---|---|---|---|---|---|---|---|---|---|---|---|---|
| | D1 | D1 | D1 | D1 | | | | | | | S | S | S | S |

For rank 1, the second codebook C₂ may be obtained by applying the diagonal operation to C_{2,k}. Accordingly,

$${C}_{2 , 1 … 4} = \{ [ \begin{matrix}1 & & & \\ & 1 & & \\ & & 1 & \\ & & & 1\end{matrix} ] , [ \begin{matrix}1 & & & \\ & 1 & & \\ & & - 1 & \\ & & & - 1\end{matrix} ] , [ \begin{matrix}1 & & & \\ & 1 & & \\ & & j & \\ & & & j\end{matrix} ] , [ \begin{matrix}1 & & & \\ & 1 & & \\ & & - j & \\ & & & - j\end{matrix} ] \}$$

$$and$$

$${C}_{2 , 5 … 8} = \{ \begin{matrix}[ \begin{matrix}1 & & & \\ & {e}^{- jπ / 32} & & \\ & & {e}^{- j2π / 32} & \\ & & & {e}^{- j3π / 32}\end{matrix} ] , & [ \begin{matrix}1 & & & \\ & {e}^{jπ / 32} & & \\ & & {e}^{j2π / 32} & \\ & & & {e}^{j3π / 32}\end{matrix} ] , \\ [ \begin{matrix}1 & & & \\ & {e}^{- j3π / 32} & & \\ & & {e}^{- j6π / 32} & \\ & & & {e}^{- j9π / 32}\end{matrix} ] , & [ \begin{matrix}1 & & & \\ & {e}^{j3π / 32} & & \\ & & {e}^{j6π / 32} & \\ & & & {e}^{j9π / 32}\end{matrix} ]\end{matrix} \}$$

$$may be transformed to {C}_{2 , 1 , 1 … 4} = \{ [ \begin{matrix}1 \\ 1 \\ 1 \\ 1\end{matrix} ] , [ \begin{matrix}1 \\ 1 \\ - 1 \\ - 1\end{matrix} ] , [ \begin{matrix}1 \\ 1 \\ j \\ j\end{matrix} ] , [ \begin{matrix}1 \\ 1 \\ - j \\ - j\end{matrix} ] \}$$

$$and$$

$${C}_{2 , 1 , 5 … 8} = \{ [ \begin{matrix}1 \\ {e}^{- jπ / 32} \\ {e}^{- j2π / 32} \\ {e}^{- j3π / 32}\end{matrix} ] , [ \begin{matrix}1 \\ {e}^{jπ / 32} \\ {e}^{j2π / 32} \\ {e}^{j3π / 32}\end{matrix} ] , [ \begin{matrix}1 \\ {e}^{- j3π / 32} \\ {e}^{- 6 π / 32} \\ {e}^{- j9π .32}\end{matrix} ] , [ \begin{matrix}1 \\ {e}^{j3π / 32} \\ {e}^{j6π / 32} \\ {e}^{j9π / 32}\end{matrix} ] \} .$$

For rank 1, each of the second codewords included in the second codebook C₂ may include diagonal elements present in at least one matrix of

$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] .$$

For rank 2, each of the second codewords included in the second codebook C₂ may include diagonal elements present in at least one matrix of

$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] .$$

In the above example, the second codebook C₂ may be given as

$${C}_{2 , 2 , 1 … 4} = \{ [ \begin{matrix}1 & \\ 1 & \\ 1 & \\ 1 & \\ & 1 \\ & 1 \\ & 1 \\ & 1\end{matrix} ] , [ \begin{matrix}1 & \\ 1 & \\ - 1 & \\ - 1 & \\ & 1 \\ & 1 \\ & - 1 \\ & - 1\end{matrix} ] , [ \begin{matrix}1 & \\ 1 & \\ j & \\ j & \\ & 1 \\ & 1 \\ & j \\ & j\end{matrix} ] , [ \begin{matrix}1 & \\ 1 & \\ - j & \\ - j & \\ & 1 \\ & 1 \\ & - j \\ & - j\end{matrix} ] \}$$

$$and$$

$${C}_{2 , 2 , 5 … 8} = \{ [ \begin{matrix}1 & \\ {e}^{- jπ / 32} & \\ {e}^{- j2π / 32} & \\ {e}^{- j3π / 32} & \\ & 1 \\ & {e}^{- jπ / 32} \\ & {e}^{- j2π / 32} \\ & {e}^{- j3π / 32}\end{matrix} ] , [ \begin{matrix}1 & \\ {e}^{jπ / 32} & \\ {e}^{j2π / 32} & \\ {e}^{j3π / 32} & \\ & 1 \\ & {e}^{jπ / 32} \\ & {e}^{j2π / 32} \\ & {e}^{j3π / 32}\end{matrix} ] , [ \begin{matrix}1 & \\ {e}^{- j3π / 32} & \\ {e}^{- j6π / 32} & \\ {e}^{- j9π / 32} & \\ & 1 \\ & {e}^{- j3π / 32} \\ & {e}^{- j6π / 32} \\ & {e}^{- j9π / 32}\end{matrix} ] \}$$

In this example, the T matrix may correspond to a diagonal matrix for rank 1. The T matrix T₁ may have a form of the following non-diagonal matrix.

$${T}_{1} = [ \begin{matrix}1 & {ρ}_{0} {e}^{jθ0} & {ρ}_{0}^{2} {e}^{{j2θ}_{0}} & {ρ}_{0}^{3} {e}^{{j3θ}_{0}} \\ {ρ}_{0} {e}^{- {jθ}_{0}} & 1 & {ρ}_{0} {e}^{{jθ}_{0}} & {ρ}_{0}^{2} {e}^{{j2θ}_{0}} \\ {ρ}_{0}^{2} {e}^{- {j2θ}_{0}} & {ρ}_{0} {e}^{- {jθ}_{0}} & 1 & {ρ}_{0} {e}^{{jθ}_{0}} \\ {ρ}_{0}^{3} {e}^{- {j3θ}_{0}} & {ρ}_{0}^{2} {e}^{- {j2θ}_{0}} & {ρ}_{0} {e}^{- {jθ}_{0}} & 1\end{matrix} ]$$

In the T₁ matrix, ρ₀ may correspond to a value associated with a channel correlation and be quantized to a plurality of candidate values.

### Adaptive Codebook

Exemplary embodiments may provide an adaptive codebook used in an adaptive mode. According to exemplary embodiments, a precoding matrix W used by the transmitter may be expressed by W=W₁W₂. In this example, W₂ may be well defined based on various standards, for example, a 3GPP LTE Release 8 standard and the like. Matrices W₁ may be selected as non-diagonal matrices T1. The precoding matrix W may also be defined as W=W₁W₂/∥W₁W₂∥.

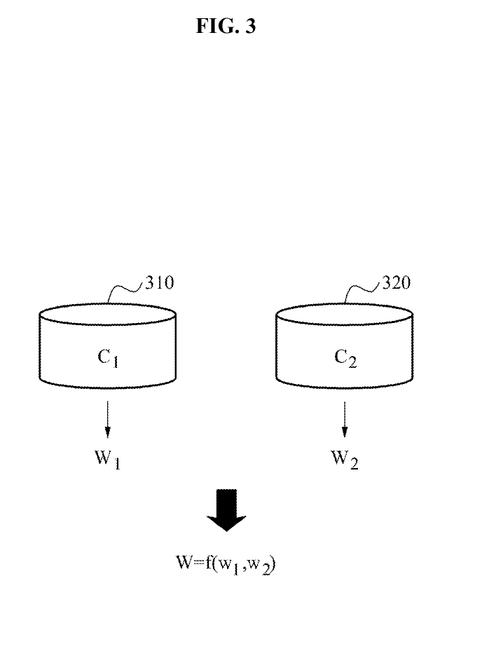

FIG. 3 illustrates a conceptual relationship between two codebooks and a precoding matrix according to an exemplary embodiment of the present invention.

Referring to FIG. 3, both a transmitter and a receiver may store a first codebook C₁ 310 and a second codebook C₂ 320. The receiver may select a preferred first codeword from the first codebook C₁ 310, and may select a preferred second codeword from the second codebook C₂ 320. A first precoding matrix indicator may be fed back to the transmitter as an index of the preferred first codeword, and a second precoding matrix indicator may be fed back to the transmitter as an index of the preferred second codeword.

The transmitter may find the preferred first codeword from the first codebook C₁ 310 based on the first precoding matrix indicator and the second precoding matrix indicator, and may find the preferred second codeword from the second codebook C₂ 320. The transmitter may determine a precoding matrix W=f(W₁, W₂) based on the preferred first codeword and the preferred second codeword.

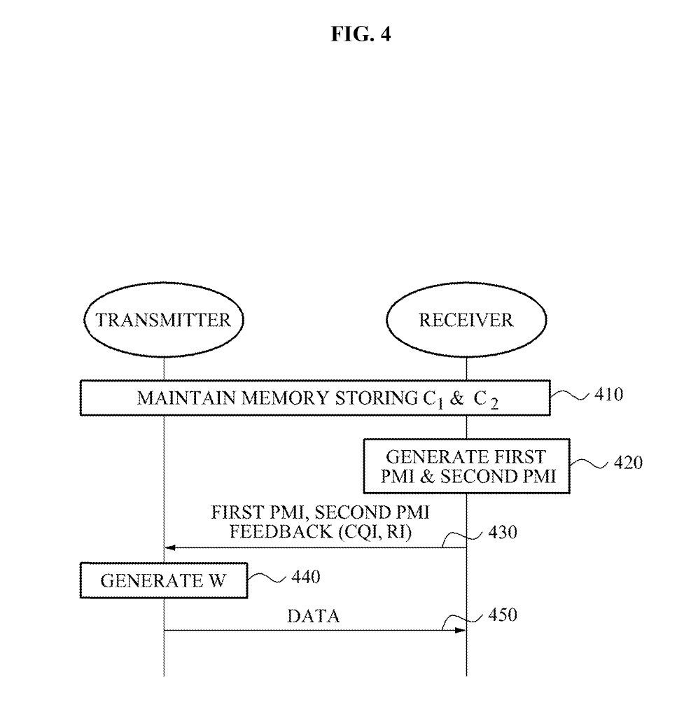

FIG. 4 illustrates a communication method of a receiver and a transmitter to share channel information using two codebooks according to an exemplary embodiment of the present invention.

A rotation-based differential codebook W₂W₁ case and a transformation-based differential codebook will be described with reference to FIG. 4.

Rotation-Based Differential Codebook W₂W₁ Case:

At step 410, the transmitter and the receiver may maintain a memory storing a first codebook C₁ defined in known standards and a second codebook C₂ that may be defined based on Table 1 through Table 3.

At step 420, when the receiver measures a channel formed between the transmitter and the receiver, the receiver may generate a first precoding matrix indicator corresponding to W₁ selected from the first codebook C₁, and may generate a second precoding matrix indicator corresponding to W₂ selected from the second codebook C₂.

At step 430, the receiver may feed back the first precoding matrix indicator and the second precoding matrix indicator to the transmitter. The receiver may further feed back channel quality information and a rank indicator.

At step 440, the transmitter may find W₁ and W₂ based on the first precoding matrix indicator and the second precoding matrix indicator and generate a precoding matrix W based on W=W₂W₁.

At step 450, the transmitter may precode a data stream based on the precoding matrix W and may transmit data using a plurality of transmit antennas, for example, 2, 4, 8, and the like.

Transformation-Based Differential Codebook Case:

At step 410, the transmitter and the receiver may maintain a memory storing a first codebook C₁ and a second codebook C₂ including a plurality of C_{2,r,k}. The first codebook C₁ may correspond to a codebook defined in known standards, and may also correspond to a codebook including a plurality of candidates of T matrix T₁. For example, since T₁ is a function of W₁ in W=T₁W₂, the transmitter and the receiver may use a codebook including candidates with respect to W₁ and may also use a codebook including candidates with respect to T₁. Hereinafter, the first precoding matrix indicator may be assumed to be generated from the codebook including candidates with respect to W₁. However, it is only an example and thus, the exemplary embodiments are not limited thereto.

At step 420, the receiver may generate the first precoding matrix indicator from the first codebook C₁ and generate the second precoding matrix indicator from the second codebook C₂.

At step 430, the receiver may feed back the first precoding matrix indicator and the second precoding matrix indicator to the transmitter. The receiver may further feed back channel quality information and a rank indicator.

Although not illustrated in FIG. 4, the transmitter may find W₁ based on the first precoding matrix indicator and may find the T matrix based on T₁=diag(W₁) and T₁=[diag(w₁)diag(w₂)].

At step 440, the transmitter may generate a precoding matrix W=T₁W₂ based on T matrix and W₂.

At step 450, the transmitter may precode a data stream based on the precoding matrix W and may transmit data using a plurality of transmit antennas, for example, 2, 4, 8, and the like.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape, optical media such as CD ROM disks and DVDs, magneto-optical media such as optical disks, and hardware devices that are specially configured to store and perform program instructions, such as Read-Only Memory (ROM), Random Access Memory (RAM), flash memory, and the like. Examples of program instructions include both machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and non-transitory computer-readable codes or program instructions may be stored and executed in a decentralized manner.

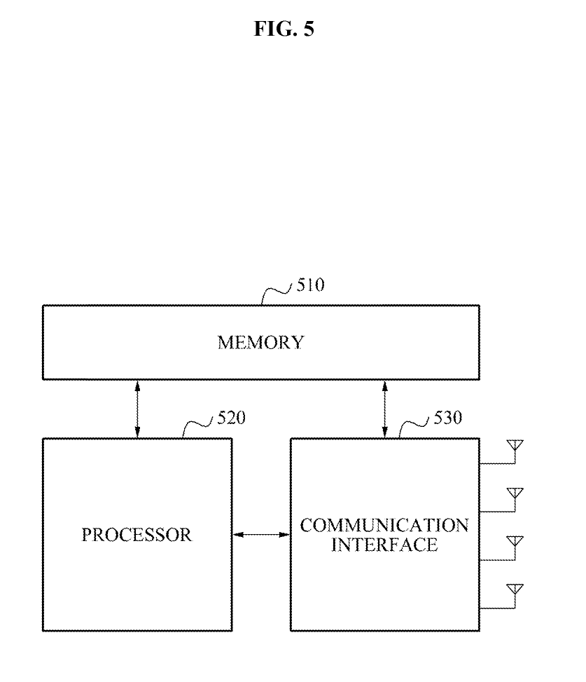

FIG. 5 illustrates a communication apparatus according to an exemplary embodiment of the present invention.

Referring to FIG. 5, the communication apparatus may include a memory 510, a processor 520, and a communication interface 530. The communication apparatus may be installed in any of a receiver and a transmitter.

When the Communication Apparatus is Installed in the Receiver:

The memory 510 may store a first codebook including first codewords and a second codebook including second codewords.

Based on the first codewords and the second codewords stored in the memory 510, the processor 520 may generate a first precoding matrix indicator corresponding to one of the first codewords and may generate a second precoding matrix indicator corresponding to one of the second codewords.

Assuming W=W₂W₁ or W=T₁W₂, the processor 520 may generate the first precoding matrix indicator and the second precoding matrix indicator. The processor 520 may determine T₁.

The communication interface 530 may transmit, to the transmitter, the first precoding matrix indicator corresponding to W₁ or T₁ and the second precoding matrix indicator corresponding to W₂.

When the Communication Apparatus is Installed in the Transmitter:

The memory 510 may store the first codebook including first codewords and the second codebook including second codewords.

The communication interface 530 may receive the first precoding matrix indicator and the second precoding matrix indicator.

The processor 520 may extract, from the memory 510, W₁ corresponding to the first precoding matrix indicator and W₂ corresponding to the second precoding matrix indicator.

The processor 530 may generate a precoding matrix W based on W₁ and W₂.

Descriptions made above with reference to FIG. 1 through FIG. 4 are applicable to the communication apparatus of FIG. 5 and thus, further descriptions will be omitted here.

While the invention has been shown and described with reference to certain exemplary embodiments thereof, it will be understood by those skilled in the art that various changes in form and details may be made therein without departing from the spirit and scope of the invention as defined by the appended claims their equivalents.

What is claimed is:

1. A communication method of a receiver in a communication system comprising a transmitter and the receiver, the communication method comprising:
accessing a memory storing a first codebook comprising first codewords and a second codebook comprising second codewords;
generating a first precoding matrix indicator corresponding to one of the first codewords and a second precoding matrix indicator corresponding to one of the second codewords; and
transmitting, to the transmitter, the first precoding matrix indicator and the second precoding matrix indicator.

2. The communication method of claim 1, wherein when the transmitter comprises four transmit antennas, the second codewords comprise one of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$
where θ corresponds to a real number.

3. The communication method of claim 2, wherein θ corresponds to one of 0, π, π/2, −π/2, −π/8, π/8, −π/16, π/16, −3π/16, 3π/16, −π/32, π/32, −3π/32, and 3π/32.

4. The communication method of claim 1, wherein, when a plurality of subbands are present, the first precoding matrix indicator indicates one of a property of a channel in a wideband comprising the plurality of subbands and a long-term property of the channel, and the second precoding matrix indicator indicates one of the property of the channel in each of the plurality of subbands and a short-term property of the channel.

5. The communication method of claim 1, wherein the generating comprises generating the first precoding matrix indicator and the second precoding matrix indicator based on a channel formed between the transmitter and the receiver.

6. The communication method of claim 1, wherein when the transmitter comprises four transmit antennas, and at least two of the second codewords comprise at least two of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] .$$

7. The communication method of claim 1, wherein a precoding matrix of the transmitter for the receiver is determined based on the first precoding matrix indicator and the second precoding matrix indicator.

8. A communication method of a receiver in a communication system comprising a transmitter and the receiver, the communication method comprising:
accessing a memory storing a first codebook comprising first codewords and a second codebook comprising second codewords;
generating a first precoding matrix indicator corresponding to one of the first codewords and a second precoding matrix indicator corresponding to one of the second codewords; and
transmitting, to the transmitter, the first precoding matrix indicator and the second precoding matrix indicator,
wherein the first precoding matrix indicator indicates a preferred T matrix that is defined by applying a diagonal operation to at least one column vector included in one of the first codewords, and at least one column vector included in each of the second codewords comprises diagonal elements present in at least one matrix of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$
where θ corresponds to a real number.

9. The communication method of claim 8, wherein each of the second codewords corresponds to a diagonal block matrix comprising at least two blocks, and the at least two blocks are identical to each other.

10. The communication method of claim 8, wherein at least one column vector included in each of the second codewords corresponds to a column vector generated by applying the diagonal operation to at least one matrix of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$
or comprises all of elements included in the generated column vector.

11. The communication method of claim 8, wherein:
when a transmission rank of the transmitter is ‘1’, the first precoding matrix indicator indicates the T matrix comprising, as diagonal elements, elements included in a corresponding first codeword and,
when the transmission rank of the transmitter is ‘2’, the first precoding matrix indicator indicates the T matrix generated by applying the diagonal operation to each of two column vectors included in the corresponding first codeword.

12. The communication method of claim 8, wherein a precoding matrix of the transmitter for the receiver is defined based on the T matrix indicated by the first precoding matrix indicator and a second codeword indicated by the second precoding matrix indicator.

13. A communication method of a transmitter in a communication system comprising the transmitter and a receiver, the communication method comprising:
receiving a first precoding matrix indicator and a second precoding matrix indicator;
accessing a memory storing a first codebook comprising first codewords and a second codebook comprising second codewords; and
generating a precoding matrix based on a first codeword indicated by the first precoding matrix indicator and a second codeword indicated by the second precoding matrix indicator,
wherein each of the second codewords corresponds to a diagonal matrix.

14. The communication method of claim 13, wherein when the transmitter comprises four transmit antennas, the second codewords comprise one of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$
where θ corresponds to a real number.

15. A communication method of a transmitter in a communication system comprising the transmitter and a receiver, the communication method comprising:
receiving a first precoding matrix indicator and a second precoding matrix indicator;
accessing a memory storing a first codebook comprising first codewords and a second codebook comprising second codewords; and
generating a precoding matrix based on a first codeword indicated by the first precoding matrix indicator and a second codeword indicated by the second precoding matrix indicator,
wherein the precoding matrix indicator indicates a preferred T matrix that is defined by applying a diagonal operation to at least one column vector included in one of the first codewords, and
at least one column vector included in each of the second codewords comprises diagonal elements present in at least one matrix of
$$[ \begin{matrix}1 & 0 & 0 & 0 \\ 0 & {e}^{jθ} & 0 & 0 \\ 0 & 0 & {e}^{j2θ} & 0 \\ 0 & 0 & 0 & {e}^{j3θ}\end{matrix} ] , [ \begin{matrix}1 & 0 & 0 & 0 \\ 0 & 1 & 0 & 0 \\ 0 & 0 & {e}^{jθ} & 0 \\ 0 & 0 & 0 & {e}^{jθ}\end{matrix} ] , and [ \begin{matrix}1 & 0 & 0 & 0 \\ 0 & {e}^{jθ} & 0 & 0 \\ 0 & 0 & 1 & 0 \\ 0 & 0 & 0 & {e}^{jθ}\end{matrix} ] ,$$
where θ corresponds to a real number.

16. A non-transitory computer-readable recording medium storing a program to implement the method of claim 1.

17. A communication apparatus of a receiver in a communication system, the apparatus comprising:
a memory for storing a first codebook comprising first codewords and a second codebook comprising second codewords;
a processor for generating a first precoding matrix indicator corresponding to one of the first codewords and a second precoding matrix indicator corresponding to one of the second codewords; and
a communication interface for transmitting the first precoding matrix indicator and the second precoding matrix indicator.

18. The communication apparatus of claim 17, wherein when a plurality of subbands are present, the first precoding matrix indicator indicates a property of a channel in a wideband comprising the plurality of subbands or a long-term property of the channel, and the second precoding matrix indicator indicates the property of the channel in each of the plurality of subbands or a short-term property of the channel.

19. The communication apparatus of claim 17, wherein the processor generates the first precoding matrix indicator and the second precoding matrix indicator based on a channel formed between a transmitter and the receiver.

20. A communication apparatus of a transmitter in a communication system, the communication apparatus comprising:
a communication interface for receiving a first precoding matrix indicator and a second precoding matrix indicator;
a memory for storing a first codebook comprising first codewords and a second codebook comprising second codewords; and
a processor for generating a precoding matrix based on a first codeword indicated by the first precoding matrix indicator and a second codeword indicated by the second precoding matrix indicator,
wherein each of the second codewords corresponds to a diagonal matrix.
